(19) United States
(12) Patent Application Publication
(10) Pub. No.: US 2022/0406337 A1
(43) Pub. Date: Dec. 22, 2022

(54) SEGMENTATION CONTOUR SYNCHRONIZATION WITH BEAT

(71) Applicant: Lemon Inc., Grand Cayman (KY)

(72) Inventors: Yunzhu Li, Los Angeles, CA (US); Zihao Chen, Los Angeles, CA (US); Chen Sun, Los Angeles, CA (US)

(21) Appl. No.: 17/353,441

(22) Filed: Jun. 21, 2021

(51) Int. Cl. G11B 27/031

(52) U.S. Cl. CPC G11B 27/031

(57) ABSTRACT

Systems and methods for rendering a segmentation contour effect are described. More specifically, video data including one or more video frames and audio data are obtained. Based on the video data, one or more segments in each of the one or more video frame are determined. The audio data is analyzed to determine beat characteristics of each beat. A segmentation contour effect to be applied to the one or more segments in the video data is determined based on the beat characteristics. A rendered video is generated by synchronizing the segmentation contour effect to audio data.

### BACKGROUND

Video editing techniques are widely available to provide users various way to edit videos. For example, the users may edit a video to add a visual effect and/or music to the video. However, many of the video editing techniques do not consider controlling the visual effect based on audio data. Hence, there remains a need to develop video editing techniques for rendering audio-video synchronization to enhance the user experience.

It is with respect to these and other general considerations that the aspects disclosed herein have been described. Also, although relatively specific problems may be discussed, it should be understood that the examples should not be limited to solving the specific problems identified in the background or elsewhere in this disclosure.

### SUMMARY

In accordance with at least one example of the present disclosure, a method for rendering a segmentation contour effect is provided. The method may include obtaining, by a computing device, video data including one or more video frames, determining, by the computing device, one or more segments in each of the one or more video frames, obtaining, by the computing device, audio data, analyzing, by the computing device, the audio data to determine beat characteristics of each beat, determining, by the computing device, a segmentation contour effect to be applied to the one or more segments in the video data based on the beat characteristics, and generating, by the computing device, a rendered video by synchronizing the segmentation contour effect to audio data.

In accordance with at least one example of the present disclosure, a computing device for rendering a segmentation contour effect is provided. The computing device may include a processor and a memory having a plurality of instructions stored thereon that, when executed by the processor, causes the computing device to: obtain video data including one or more video frames, determine one or more segments in each of the one or more video frames, obtain audio data, analyze the audio data to determine beat characteristics of each beat, determine a segmentation contour effect to be applied to the one or more segments in the video data based on the beat characteristics, and generate a rendered video by synchronizing the segmentation contour effect to audio data.

In accordance with at least one example of the present disclosure, a non-transitory computer-readable medium storing instructions for rendering a segmentation contour effect is provided. The instructions when executed by one or more processors of a computing device, cause the computing device to: obtain video data including one or more video frames, determine one or more segments in each of the one or more video frames, obtain audio data, analyze the audio data to determine beat characteristics of each beat, determine a segmentation contour effect to be applied to the one or more segments in the video data based on the beat characteristics, and generate a rendered video by synchronizing the segmentation contour effect to audio data.

Any of the one or more above aspects in combination with any other of the one or more aspects. Any of the one or more aspects as described herein.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts an example audio-video synchronization system in accordance with examples of the present disclosure;

FIG. 2 depicts details of a computing device of the audio-video synchronization system of FIG. 1 in accordance with examples of the present disclosure;

FIGS. 3A-3C depict example frames of a video rendered with segmentation contour effect;

FIG. 4 depicts details of a method for rendering segmentation contour effect in accordance with examples of the present disclosure;

FIG. 5 depicts a block diagram illustrating physical components (e.g., hardware) of a computing device with which aspects of the disclosure may be practiced;

FIG. 6A illustrates a first example of a computing device with which aspects of the disclosure may be practiced;

FIG. 6B illustrates a second example of a computing device with which aspects of the disclosure may be practiced; and

FIG. 7 illustrates at least one aspect of an architecture of a system for processing data in accordance with examples of the present disclosure.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In accordance with examples of the present disclosure, an audio-video synchronization system allows a user to apply audio-reactive segmentation contour effects to one or more body segments of a target subject in a video clip. More specifically, the segmentation contour effect adds one or more segmentation contours on boundaries of one or more body segments identified in the video clip based on beat characteristics of audio music. To do so, body segmentation may be performed to separate or segregate body segments from one or more target subjects of the video clip. Additionally, music beat characterization may be performed to capture beat information of the music selected by a user to be added to the video clip. In some aspects, the music beat characterization may be embedded in the music as metadata. The music beat characterization may include a number and relative positions of accented and unaccented beats of the music.

The segmentation contour effect includes contour effects parameters that define behavior of the segmentation contour effect that is to be added to one or more body segments in the video data. In some aspects, the contour effects parameters may define, but are not limited to, one or more body segments that the segmentation contour effect is being applied to and how the one or more body segments are selected for segmentation contour effect application throughout the video clip. The contour effects parameters may further define a color, width, height, thickness, and brightness of a segmentation contour of the segmentation contour effect for each body segment. Additionally, the contour effects parameters may define a number of segmentation contours for a particular body segment to be added to the video clip. Accordingly, the parameters of the segmentation contour effect may be periodically (e.g., every beat) updated based on the audio music and the video clip. The audio-video synchronization allows the segmentation contour effect to react to the music beat of the music that is being added to the video clip.

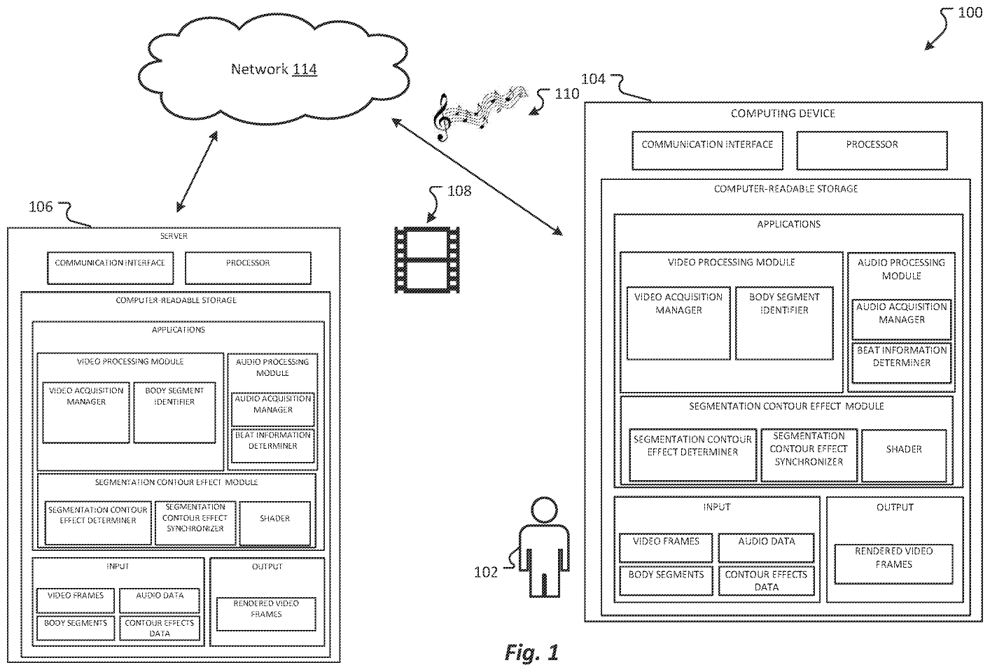

FIG. 1 depicts an audio-video synchronization system 100 for rendering one or more segmentation contour effects in accordance with examples of the present disclosure. For example, a user 102 may generate, receive, acquire, or otherwise obtain a video clip 108. Subsequently, the user may select audio music 110 to be added to the video clip 108. The audio-video synchronization system 100 allows the user 102 to create an audio-reactive segmentation contour effect that follows one or more target body segments of a target subject in the video clip 108 based on the music 110. To do so, the audio-video synchronization system 100 includes a computing device 104 associated with the user 102 and a server 106 that is communicatively coupled to the computing device 104 via a network 114. The network 114 may include any kind of computing network including, without limitation, a wired or wireless local area network (LAN), a wired or wireless wide area network (WAN), and/or the Internet.

In examples, the user 102 may utilize the computing device 104 to acquire the video clip 108 and the music 110. The user 102 may generate the video clip 108 using a camera communicatively coupled to a computing device 104. In such an example, the segmentation contour effect may be synchronized to the music 110 in or near real-time to allow the user 102 to view the segmentation contour effect around the one or more body segments on a display (e.g., a display 605) as the user is taking the video on the computing device 104. Alternatively, or additionally, the user 102 may receive, acquire, or otherwise obtain the video clip 108 on the computing device 104. In some examples, the user 102 may edit the video clip 108 to add the segmentation contour effect based on the music 110. In some aspects, the user 102 may utilize the computing device 104 to transmit the video clip 108 and the music 110 to the server 106 via the network 114. The computing device 104 may be any one of a portable or non-portable computing device. For example, the computing device 104 may be a smartphone, a laptop, a desktop, a wearable electronic device, a smart home appliance, and a server. The video clip 108 may be acquired in any format and may be in a compressed and/or decompressed form.

The computing device 104 is configured to analyze each frame of the video clip 108 to identify body segments of one or more target subjects in the frame. For example, a body segmentation algorithm may define a list of body segments that are to be identified and extracted from the video clip 108. The body segments may include, but not limited to, head (e.g., hair, hat), facial (e.g., face, glasses, mask), torso skin, top (e.g., jacket, dress, coat, scarf), bottom (e.g., pants, shorts, skirts), hand (e.g., arm skin, gloves), and legs (e.g., leg skin, shoes, socks).

The computing device 104 is configured to receive audio music 110 selected by the user 102 to be added to the video clip 108 or preset by the audio-video synchronization system 100. Alternatively, in some aspects, the audio music 110 may be associated with the segmentation contour effect. In some aspects, the segmentation contour effect may include default music to be added to the video clip 108 or preset by the audio-video synchronization system 100. The computing device 104 is configured to analyze the audio data to determine beat information of the audio music 110. For example, the computing device 104 may determine beat characteristics of each beat through an automatic beat tracking algorithm. It should be appreciated that, in some aspects, the music beat characterization may be embedded in the music as metadata. The music beat characterization may include a number and relative positions of accented and unaccented beats of the audio music 110. For example, if the audio music 110 has a 4/4 beat structure, each section has four beats with different beat intensity: strong beat, weak beat, second strong beat, and weak beat.

The segmentation contour effect includes contour effects parameters that define behavior of the segmentation contour effect that is to be added to one or more body segments in the video data. In some aspects, the contour effects parameters may define, but are not limited to, one or more body segments that the segmentation contour effect is being applied to and how the one or more body segments are selected for segmentation contour effect application throughout the video clip. The contour effects parameters may further define a color, width, height, thickness, and brightness of a segmentation contour for each body segment. Additionally, the contour effects parameters may define a number of segmentation contours for a particular body segment to be added to the video clip. Accordingly, the parameters of the segmentation contour effect may be periodically (e.g., every beat) updated based on the audio music and the video clip. In other words, the audio-video synchronization allows the segmentation contour effect to react to music beat.

Additionally, the computing device 104 is further configured to determine a segmentation contour effect to be applied to the video data based on the audio data. In the illustrative aspect, the segmentation contour effect changes with every beat. In other words, the beat of the selected audio music controls the visualization change of the segmentation contour effect on the one or more body segments.

In some aspects, the user may choose a segmentation contour effect to be applied to the video clip 108 to generate a segmentation contour with a particular effect around boundaries of one or more body segments defined by contour effects parameters. The segmentation contour effect includes one or more contour effects parameters. The contour effects parameters define one or more body segments that the segmentation contour effect is being applied to and how the one or more body segments are selected for segmentation contour effect application throughout the video clip. For example, the segmentation contour effect may be applied to a particular set of body segments randomly throughout the video clip. Alternatively, the segmentation contour effect may be applied to the video clip in a particular sequence (e.g., head to toe). Alternatively, the segmentation contour effect may be applied to a particular body segment based on the beat intensity of the music. For example, the head may be assigned to a strong beat, the top may be assigned to a weak beat, and the pants may be assigned to a second strong beat.

Additionally, the contour effects parameters may further define a color, width, height, thickness, and brightness of a segmentation contour for each body segment. For example, orange may be assigned to the head, green may be assigned to the facial, red may be assigned to the torso skin, turquoise may be assigned to the top, blue may be assigned to the pants, purple may be assigned to the hand, and pink may be assigned to the legs. In some aspects, the thickness and brightness of the segmentation contour are based on the beat intensity of the music. For example, the segmentation contour becomes thicker and brighter on the strong beat and becomes thinner and dimmer on the weak beat.

Additionally, the contour effects parameters may define a number of segmentation contours for a particular body segment to be added to the video clip. The number of segmentation contours may be associated with the body segment and/or the beat intensity. For example, five segmentation contours are generated around a particular body segment on the strong beat, three segmentation contours are generated for the second strong beat, and one segmentation contour is generated for the weak beat.

The computing device 104 is configured to synchronize the segmentation contour effect to the music beat of the audio music to generate a rendered video with the segmentation contour effect, which may be presented to the user on a display (e.g., a display 605) that is communicatively coupled to the computing device 104. It should be appreciated that the segmentation contour effect may be synchronized to the music beat in or near real-time to allow the user to view the segmentation contour effect around the one or more body segments on the display as the user is taking the video.

Alternatively, or additionally, the segmentation contour effect may be synchronized to the music beat by the server 106. In such aspects, the segmentation contour effect may be applied to the video clip 108 once the video clip 108 is uploaded to the server 106 to render the segmentation contour effect.

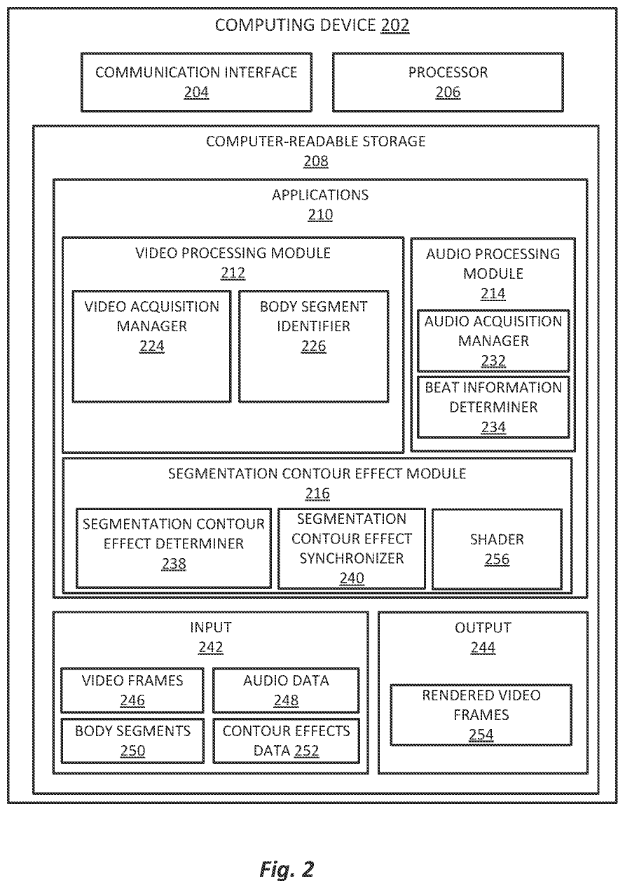

Referring now to FIG. 2, the computing device 202 in accordance with examples of the present disclosure is provided. The computing device 202 may be the same as or similar to the computing device 104 previously described in FIG. 1. The computing device 202 may include a communication interface 204, a processor 206, and a computer-readable storage 208. In examples, the communication interface 204 may be coupled to a network and receive the video clip 108 and the audio music 110 (FIG. 1). The video clip 108 (FIG. 1) may be stored as video frames 246 and the music 110 may be stored as audio data 248.

In some examples, one or more contour effects may also be received at the communication interface 204 and stored as the contour effects data 252. The contour effects data 252 may include one or more contour effects parameters. The contour effects parameters may define, but are not limited to, one or more body segments that the segmentation contour effect is being applied to and how the one or more body segments are selected for segmentation contour effect application throughout the video clip. The contour effects parameters may further define a color, width, height, thickness, and brightness of a segmentation contour for each body segment. Additionally, the contour effects parameters may define a number of segmentation contours for a particular body segment to be added to the video clip.

In examples, one or more applications 210 may be provided by the computing device 104. The one or more applications 210 may include a video processing module 212, an audio processing module 214, and a segmentation contour effect module 216. The video processing module 212 may include a video acquisition manager 224 and a body segment identifier 226. The video acquisition manager 224 is configured to receive, acquire, or otherwise obtain video data that includes one or more video frames. Additionally, the body segment identifier 226 is configured to identify one or more body segments of one or more target subjects in the frame. In the illustrative aspect, the target subject is a person. For example, a body segmentation algorithm may define a list of body segments that are to be identified and extracted from the video clip 108. The body segments may include, but not limited to, head (e.g., hair, hat), facial (e.g., face, glasses, mask), torso skin, top (e.g., jacket, dress, coat, scarf), bottom (e.g., pants, shorts, skirts), hand (e.g., arm skin, gloves), and legs (e.g., leg skin, shoes, socks). In some examples, the list of body segments may be received at the communication interface 204 and stored as the body segments 250. In some aspects, the list of body segments may be received from a server (e.g., 106).

Additionally, the audio processing module 214 may include an audio acquisition manager 232 and a beat information determiner 234. The audio acquisition manager 232 is configured to receive, acquire, or otherwise obtain audio data. The beat information determiner 234 is configured to determine beat information of the audio data. For example, an automatic beat tracking algorithm may be used to determine the beat information. In some aspects, the beat information may be already embedded in the audio data as metadata. In other aspects, the beat information may be received at the communication interface 204 and stored as the audio data 248. The beat information provides beat characteristics of each beat. The beat characteristics include, but not limited to, a beat structure, a repeating sequence of strong and weak beats, a number of accented and unaccented beats, and relative positions of accented and unaccented beats. For example, if the audio music has a 4/4 beat structure, each section has four beats with different beat intensity: strong beat, weak beat, second strong beat, and weak beat.

Furthermore, the segmentation contour effect 216 may further include a segmentation contour effect determiner 238, a segmentation contour effect synchronizer 240, and a shader 256. The segmentation contour effect determiner 238 is configured to determine a segmentation contour effect to be applied to the video data based on the audio data. In the illustrative aspect, the visualization of segmentation contour effect changes with every beat. In other words, the beat of the selected audio music controls the visual change of the segmentation contour effect on the one or more body segments.

For example, the segmentation contour effect includes one or more contour effects parameters. The contour effects parameters define one or more body segments that the segmentation contour effect is being applied to and how the one or more body segments are selected for segmentation contour effect application throughout the video clip. For example, the segmentation contour effect may be applied to a particular set of body segments randomly throughout the video clip. Alternatively, the segmentation contour effect may be applied to the video clip in a particular sequence (e.g., from top to bottom). Alternatively, the segmentation contour effect may be applied to a particular body segment based on the beat intensity of the music. For example, the head may be assigned to a strong beat, the top may be assigned to a weak beat, and the pants may be assigned to a second strong beat.

Additionally, the contour effects parameters may further define a color, width, height, thickness, and brightness of a segmentation contour that is to be applied to a particular body segment. For example, orange may be assigned to the head, green may be assigned to the facial, red may be assigned to the torso skin, turquoise may be assigned to the top, blue may be assigned to the pants, purple may be assigned to the hand, and pink may be assigned to the legs. In some aspects, the thickness and brightness of the segmentation contour are based on the beat intensity of the music. For example, the segmentation contour becomes thicker and brighter on the strong beat and becomes thinner and dimmer on the weak beat.

Additionally, the contour effects parameters may define a number of segmentation contours for a particular body segment to be added to the video clip. The number of segmentation contours may be associated with the body segment and/or the beat intensity. For example, five segmentation contours may be generated around a particular body segment on the strong beat, three segmentation contours may be generated for the second strong beat, and one segmentation contour may be generated for the weak beat.

The segmentation contour effect synchronizer 240 is configured to synchronize the segmentation contour effect to the music beat of the selected audio music to generate a rendered video with the segmentation contour effect. The segmentation contour effect synchronizer 240 includes or otherwise is in communication with the shader 256. The shader 256 is configured to receive the contour effects parameters. Based on the contour effects parameters, the shader 256 is configured to generate or otherwise cause the effect to be rendered. For example, the shader 256 may change a visual effect associated with a segmentation contour of the segmentation contour effect which may include, but is not limited to, producing blur, light bloom, (e.g., glow), lighting (e.g., shadows, highlights, and translucency), bump mapping, and distortion.

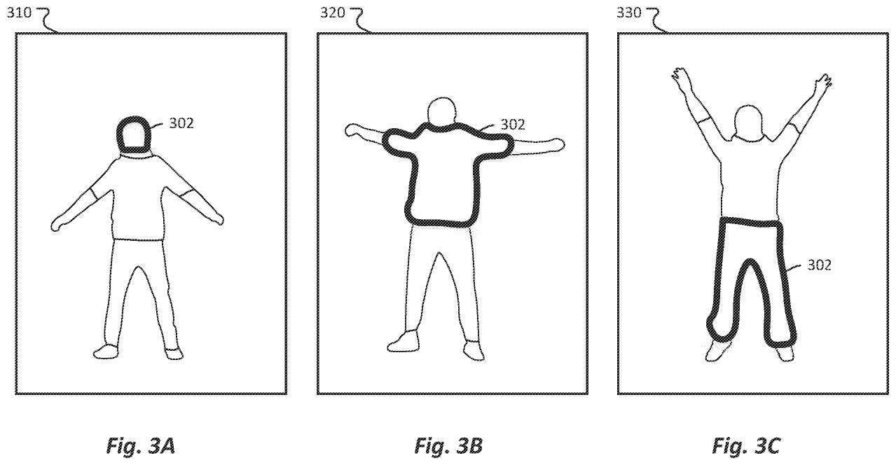

FIGS. 3A-3C illustrate exemplary video frames 310, 320, 330 of a video clip with segmentation contour effect in accordance with examples of the present disclosure. In the illustrative example, the video frames 310, 320, 330 illustrate the segmentation contour effects on three consecutive beats. Specifically, the exemplary segmentation contour effect includes one or more contour effects parameters that indicate that three body segments are to be extracted and applied in a sequence from the head, the top, and the pants as the beat changes. At beat 1, a segmentation contour 302 outlines the boundary of the head as shown in FIG. 3A. At beat 2, the segmentation contour 302 moves to outline the boundary of the top as shown in FIG. 3B. At beat 3, the segmentation contour 302 further moves to outline the boundary of the pants as shown in FIG. 3C.

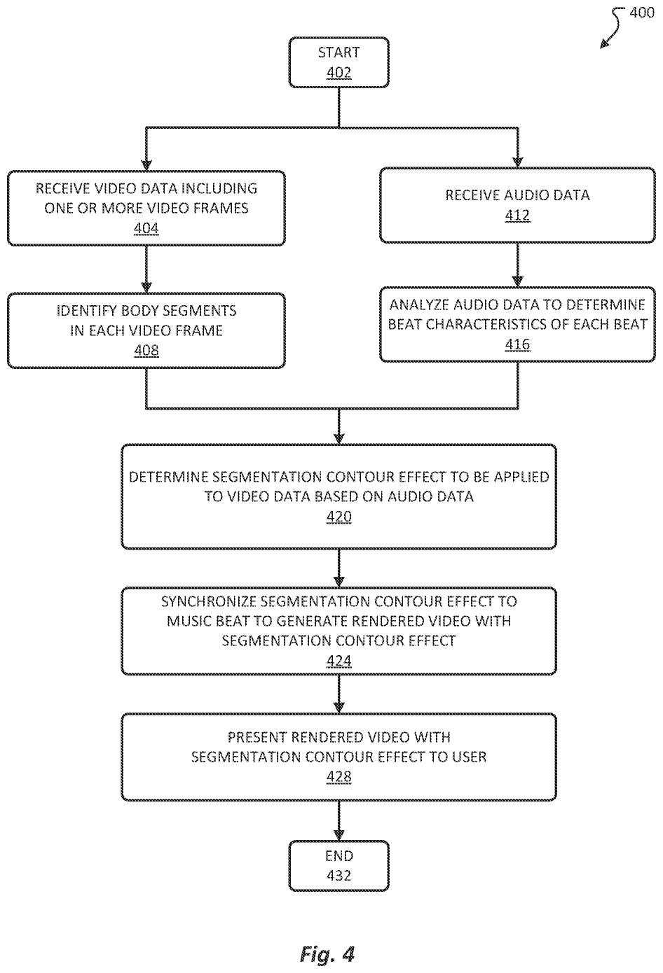

Referring now to FIG. 4, a simplified method for rendering one or more segmentation contour effects to video data based on audio data in accordance with examples of the present disclosure is described. A general order for the steps of a method 400 is shown in FIG. 4. Generally, the method 400 starts at 402 and ends at 432. The method 400 may include more or fewer steps or may arrange the order of the steps differently than those shown in FIG. 4. The method 400 can be executed as a set of computer-executable instructions executed by a computer system and encoded or stored on a computer readable medium. In the illustrative aspect, the method 400 is executed by a computing device associated with a user (e.g., 102). However, it should be appreciated that aspects of the method 400 may be performed by one or more processing devices, such as a computer or server (e.g., 104, 106). Further, the method 400 can be performed by gates or circuits associated with a processor, Application Specific Integrated Circuit (ASIC), a field programmable gate array (FPGA), a system on chip (SOC), a neural processing unit, or other hardware device. Hereinafter, the method 400 shall be explained with reference to the systems, components, modules, software, data structures, user interfaces, etc. described in conjunction with FIGS. 1-3.

The method 400 starts at 402, where flow may proceed to 404. At 404, the computing device receives video data (e.g., video clip 108) including one or more video frames. For example, a user 102 may generate, receive, acquire, or otherwise obtain a video clip 108 via the computing device. At 408, the computing device processes each frame of the video data to identify body segments of one or more target subjects in the frame. For example, a body segmentation algorithm may define a list of body segments that are to be identified and extracted from the video clip 108. The body segments may include, but not limited to, head (e.g., hair, hat), facial (e.g., face, glasses, mask), torso skin, top (e.g., jacket, dress, coat, scarf), bottom (e.g., pants, shorts, skirts), hand (e.g., arm skin, gloves), and legs (e.g., leg skin, shoes, socks). In the illustrative aspect, a list of the body segments may be defined by the body segmentation algorithm.

Referring back to the start 402, the method 400 may proceed to 412. It should be appreciated that the computing device may perform the operations 404 and 412 simultaneously. Alternatively, the operation 412 may be performed subsequent to the operation 404. In some aspects, the operation 404 may be performed subsequent to the operation 412.

At 412, the computing device receives audio data (e.g., audio music 110) selected by the user 102 to be added to the video data. Subsequently, at 416, the computing device analyzes the audio data to determine beat information of the audio music 110. For example, the computing device determines beat characteristics of each beat through an automatic beat tracking algorithm. The beat characteristics include, but not limited to, a beat structure, a repeating sequence of strong and weak beats, a number of accented and unaccented beats, and relative positions of accented and unaccented beats. For example, if the audio music 110 has a 4/4 beat structure, each section has four beats with different beat intensity: strong beat, weak beat, second strong beat, and weak beat.

Once the video data and the audio data are received and analyzed in operations 404-416, the method 400 proceeds to 420. At 420, the computing device determines a segmentation contour effect to be applied to the video data based on the audio data. In the illustrative aspect, the segmentation contour effect changes with every beat. In other words, the beat of the audio music controls the change of the segmentation contour effect on the one or more body segments.

As described above, the user may choose a segmentation contour effect to be applied to the video clip to generate a segmentation contour with a particular effect around boundaries of one or more body segments defined by contour parameters. The segmentation contour effect includes one or more contour effects parameters. The contour effects parameters define one or more body segments that the segmentation contour effect is being applied to and how the one or more body segments are selected for segmentation contour effect application throughout the video clip. For example, the segmentation contour effect may be applied to a particular set of body segments randomly throughout the video clip. Alternatively, the segmentation contour effect may be applied to the video clip in a particular sequence (e.g., head to toe). Alternatively, the segmentation contour effect may be applied to a particular body segment based on the beat intensity of the music. For example, the head may be assigned to a strong beat, the top may be assigned to a weak beat, and the pants may be assigned to a second strong beat.

Additionally, the contour effects parameters may further define a color, width, height, thickness, and brightness of a segmentation contour for each body segment. For example, orange may be assigned to the head, green may be assigned to the facial, red may be assigned to the torso skin, turquoise may be assigned to the top, blue may be assigned to the pants, purple may be assigned to the hand, and pink may be assigned to the legs. In some aspects, the thickness and brightness of the segmentation contour are based on the beat intensity of the music. For example, the segmentation contour becomes thicker and brighter on the strong beat and becomes thinner and dimmer on the weak beat.

Additionally, the contour effects parameters may define a number of segmentation contours for a particular body segment to be added to the video clip. The number of segmentation contours may be associated with the body segment and/or the beat intensity. For example, five segmentation contours may be generated around a particular body segment on the strong beat, three segmentation contours may be generated for the second strong beat, and one segmentation contour may be generated for the weak beat.

Subsequently, at 424, the segmentation contour effect is synchronized to the music beat of the selected audio music to generate a rendered video with the segmentation contour effect. At 428, the computing device presents the rendered video with the segmentation contour effect to the user on a display (e.g., a display 605). It should be appreciated that the segmentation contour effect may be synchronized to the music beat in or near real-time to allow the user to view the segmentation contour effect around the one or more body segments on a display (e.g., a display 605) as the user is taking the video. The method may end at 432.

It should be appreciated that, although the method 400 is described to be performed by the computing device associated with the user, one or more operations of the method 400 may be performed by any computing device or server, such as the server 106. For example, the synchronization of the segmentation contour effect to the music beat may be performed by the server, which receives the music and the video clip from the computing device associated with a user.

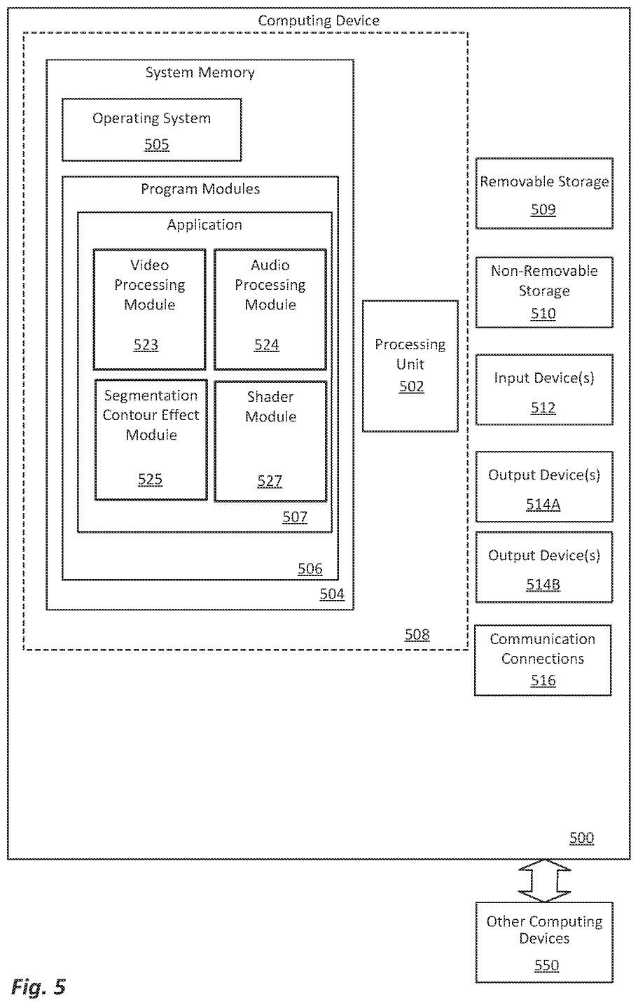

FIG. 5 is a block diagram illustrating physical components (e.g., hardware) of a computing device 500 with which aspects of the disclosure may be practiced. The computing device components described below may be suitable for the computing devices described above. For example, the computing device 500 may represent the computing device 104 of FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for performing the various aspects disclosed herein such. The operating system 505, for example, may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, several program modules and data files may be stored in the system memory 504. While executing on the at least one processing unit 502, the program modules 506 may perform processes including, but not limited to, one or more aspects, as described herein. The application 520 includes a video processing module 523, an audio processing module 524, a segmentation contour effect module 525, and a shader module 527, as described in more detail with regard to FIG. 1. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 500 may also have one or more input device(s) 512 such as a keyboard, a mouse, a pen, a sound or voice input device, a touch or swipe input device, etc. The output device(s) 514A such as a display, speakers, a printer, etc. may also be included. An output 514B, corresponding to a virtual display may also be included. The aforementioned devices are examples and others may be used. The computing device 500 may include one or more communication connections 516 allowing communications with other computing devices 450. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

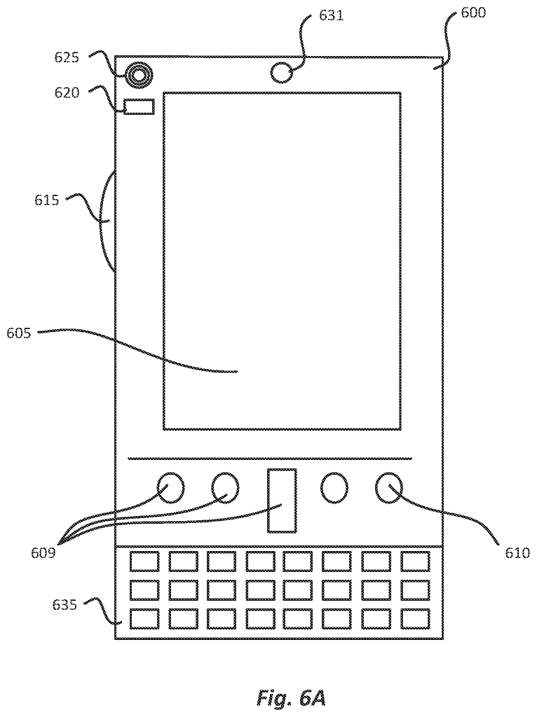

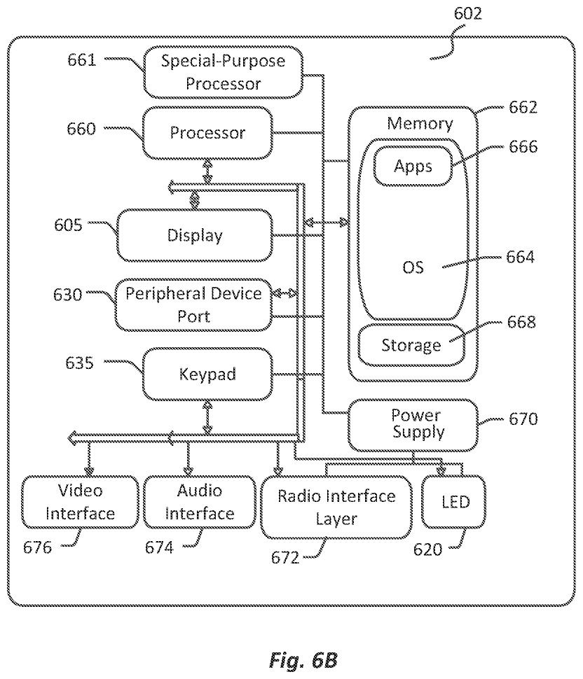

FIGS. 6A and 6B illustrate a computing device or mobile computing device 600 suitable for performing the various aspects disclosed herein, for example, a mobile telephone, a smart phone, wearable computer (such as a smart watch), a tablet computer, a laptop computer, a smart home appliance, and the like, with which aspects of the disclosure may be practiced. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 609/610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some aspects. In yet another alternative aspect, the mobile computing device 600 is a portable phone system, such as a cellular phone. The mobile computing device 600 may also include an optional keypad 635. Optional keypad 635 may be a physical keypad or a “soft” keypad generated on the touch screen display. In various aspects, the output elements include the display 605 for showing a graphical user interface (GUI), a visual indicator 631 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports 630, such as an audio input (e.g., a microphone jack), an audio output (e.g., a headphone jack), and a video output (e.g., a HDMI port) for sending signals to or receiving signals from an external source.

FIG. 6B is a block diagram illustrating the architecture of one aspect of computing device, a server, or a mobile computing device. That is, the mobile computing device 600 can incorporate a system (602) (e.g., an architecture) to implement some aspects. The system 602 can implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and/or one or more components supported by the systems described herein. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein (e.g. a video processing module 523, an audio processing module 524, a segmentation contour effect module 525, etc.).

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated configuration, the visual indicator 620 is a light emitting diode (LED) and the audio transducer 625 is a speaker. These devices may be directly coupled to the power supply 670 so that when activated, they remain on for a duration dictated by the notification mechanism even though the processor 660/661 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with aspects of the present disclosure, the microphone may also serve as an audio sensor to facilitate control of notifications, as will be described below. The system 602 may further include a video interface 676 that enables an operation of an on-board camera to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

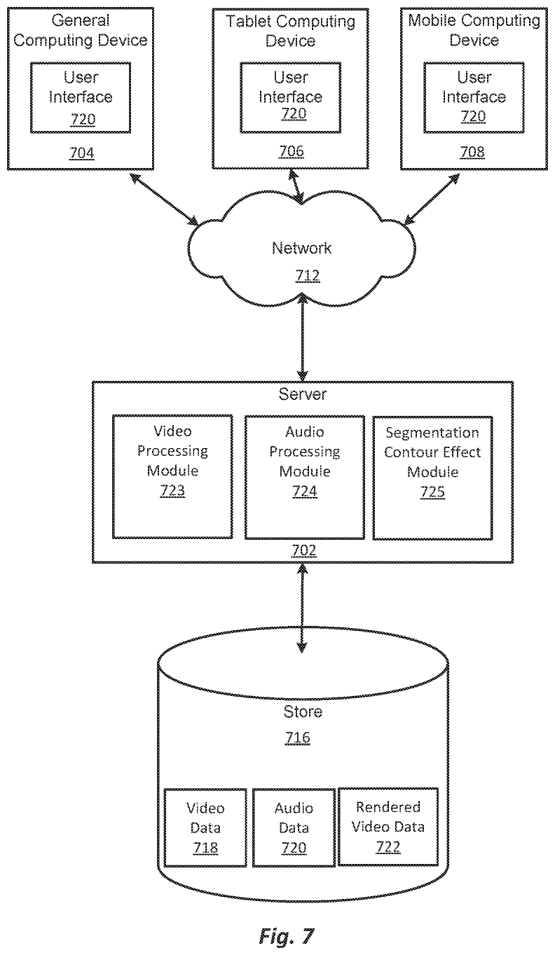

FIG. 7 illustrates one aspect of the architecture of a system for processing data received at a computing system, suitable for performing the various aspects disclosed herein, from a remote source, such as a personal computer 704, tablet computing device 706, or mobile computing device 708, as described above. Content displayed at server device 702 may be stored in different communication channels or other storage types. For example, the computing device 704, 706, 708 may represent the computing device 104 of FIG. 1, and the server device 702 may represent the server 106 of FIG. 1.

In some aspects, one or more of a video processing module 723, an audio processing module 724, and a segmentation contour effect module 725, may be employed by server device 702. The server device 702 may provide data to and from a client computing device such as a personal computer 704, a tablet computing device 706 and/or a mobile computing device 708 (e.g., a smart phone) through a network 712. By way of example, the computer system described above may be embodied in a personal computer 704, a tablet computing device 706 and/or a mobile computing device 708 (e.g., a smart phone). Any of these aspects of the computing devices may obtain content from the store 716, in addition to receiving graphical data useable to be either pre-processed at a graphic-originating system, or post-processed at a receiving computing system. The content store may include video data 718, audio data 720, and rendered video data 722.

FIG. 7 illustrates an exemplary mobile computing device 708 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

(A1) In one aspect, some examples include a method for rendering a segmentation contour effect. The method includes obtaining, by a computing device, video data including one or more video frames, determining, by the computing device, one or more segments in each of the one or more video frames, obtaining, by the computing device, audio data, analyzing, by the computing device, the audio data to determine beat characteristics of each beat, determining, by the computing device, a segmentation contour effect to be applied to the one or more segments in the video data based on the beat characteristics, and generating, by the computing device, a rendered video by synchronizing the segmentation contour effect to audio data.

(A2) In some examples of A1, wherein the segmentation contour effect comprises contour effects parameters that define one or more behaviors of the segmentation contour effect to be added to the one or more segments.

(A3) In some examples of A1-A2, wherein the contour effects parameters define one or more segments that the segmentation contour effect is being applied to or how the one or more segments are selected for segmentation contour effect application throughout the video clip.

(A4) In some examples of A1-A3, wherein the contour effects parameters define a color, width, height, thickness, and brightness of a segmentation contour for each segment.

(A5) In some examples of A1-A4, wherein the contour effects parameters define a number of segmentation contours for a particular segment to be added to the video clip based on the beat characteristics.

(A6) In some examples of A1-A5, wherein generating the rendered video by synchronizing the segmentation contour effect to audio data comprises rendering, by the computing device, the segmentation contour effects to a display based on the contour effects parameters.

(A7) In some examples of A1-A6, wherein the beat characteristics include at least one selected from a group comprising a beat structure, a repeating sequence of strong and weak beats, a number of accented and unaccented beats, and relative positions of accented and unaccented beats.

In yet another aspect, some examples include a computing system including one or more processors and memory coupled to the one or more processors, the memory storing one or more instructions which when executed by the one or more processors, causes the one or more processors perform any of the methods described herein (e.g., A1-A7 described above).

In yet another aspect, some examples include a non-transitory computer-readable storage medium storing one or more programs for execution by one or more processors of a storage device, the one or more programs including instructions for performing any of the methods described herein (e.g., A1-A7 described above).

(B1) In yet another aspect, some examples include a computing device for rendering a segmentation contour effect. The computing device may include a processor and a memory having a plurality of instructions stored thereon that, when executed by the processor, causes the computing device to: obtain video data including one or more video frames, determine one or more segments in each of the one or more video frames, obtain audio data, analyze the audio data to determine beat characteristics of each beat, determine a segmentation contour effect to be applied to the one or more segments in the video data based on the beat characteristics, and generate a rendered video by synchronizing the segmentation contour effect to audio data.

(B2) In some examples of B1, wherein the segmentation contour effect comprises contour effects parameters that define one or more behaviors of the segmentation contour effect to be added to the one or more segments.

(B3) In some examples of B1-B2, wherein the contour effects parameters define one or more segments that the segmentation contour effect is being applied to or how the one or more segments are selected for segmentation contour effect application throughout the video clip.

(B4) In some examples of B1-B3, wherein the contour effects parameters define a color, width, height, thickness, and brightness of a segmentation contour for each segment.

(B5) In some examples of B1-B4, wherein the contour effects parameters define a number of segmentation contours for a particular segment to be added to the video clip based on the beat characteristics.

(B6) In some examples of B1-B5, wherein to generate the rendered video by synchronizing the segmentation contour effect to audio data comprises to render the segmentation contour effects to a display based on the contour effects parameters.

(B7) In some examples of B1-B6, wherein the beat characteristics include at least one selected from a group comprising a beat structure, a repeating sequence of strong and weak beats, a number of accented and unaccented beats, and relative positions of accented and unaccented beats.

(C1) In one aspect, some examples include a non-transitory computer-readable medium storing instructions for rendering a segmentation contour effect, the instructions when executed by one or more processors of a computing device, cause the computing device to: obtain video data including one or more video frames, determine one or more segments in each of the one or more video frames, obtain audio data, analyze the audio data to determine beat characteristics of each beat, determine a segmentation contour effect to be applied to the one or more segments in the video data based on the beat characteristics, and generate a rendered video by synchronizing the segmentation contour effect to audio data.

(C2) In some examples of C1, wherein the segmentation contour effect comprises contour effects parameters that define one or more behaviors of the segmentation contour effect to be added to the one or more segments, wherein to generate the rendered video by synchronizing the segmentation contour effect to audio data comprises to render the segmentation contour effects to a display based on the contour effects parameters.

(C3) In some examples of C1-C2, wherein the contour effects parameters define one or more segments that the segmentation contour effect is being applied to or how the one or more segments are selected for segmentation contour effect application throughout the video clip.

(C4) In some examples of C1-C3, wherein the contour effects parameters define a color, width, height, thickness, and brightness of a segmentation contour for each segment.

(C5) In some examples of C1-C4, wherein the contour effects parameters define a number of segmentation contours to be added to the video clip based on the beat characteristics.

(C6) In some examples of C1-C5, wherein the beat characteristics include at least one selected from a group comprising a beat structure, a repeating sequence of strong and weak beats, a number of accented and unaccented beats, and relative positions of accented and unaccented beats.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for rendering a segmentation contour effect, the method comprising:
obtaining, by a computing device, video data including one or more video frames;
identifying, by the computing device, one or more body segments of one or more target subjects in each of the one or more video frames;
obtaining, by the computing device, audio data;
analyzing, by the computing device, the audio data to determine beat characteristics of each beat in the audio data;
determining, by the computing device, a segmentation contour effect to be applied to the one or more body segments of the one or more target subjects in the one or more video frames based on the determined beat characteristics, wherein the beat characteristics control visualization changes of the segmentation contour effect on the one or more body segments throughout the one or more video frames;
generating, by the computing device, the segmentation contour effect, wherein the segmentation contour effect outlines the one or more body segments of the one or more target subjects; and
generating, by the computing device, a rendered video by synchronizing the segmentation contour effect to the audio data.

2. The method of claim 1, wherein the segmentation contour effect comprises contour effects parameters that define one or more behaviors of the segmentation contour effect to be added to the one or more body segments.

3. The method of claim 2, wherein the contour effects parameters define the one or more body segments that the segmentation contour effect is being applied to or how the one or more body segments are selected for segmentation contour effect application throughout the one or more video frames.

4. The method of claim 2, wherein the contour effects parameters define a color, width, height, thickness, and brightness of a segmentation contour for each segment of the one or more body segments.

5. The method of claim 2, wherein the contour effects parameters define a number of segmentation contours for a particular body segment to be added to the one or more video frames based on the beat characteristics.

6. The method of claim 2, wherein generating the rendered video by synchronizing the segmentation contour effect to the audio data comprises rendering, by the computing device, the segmentation contour effect to a display based on the contour effects parameters.

7. The method of claim 1, wherein the beat characteristics include at least one selected from a group comprising a beat structure, a repeating sequence of strong and weak beats, a number of accented and unaccented beats, and relative positions of accented and unaccented beats.

8. A computing device for rendering a segmentation contour effect, the computing device comprising:
a processor; and
a memory having a plurality of instructions stored thereon that, when executed by the processor, causes the computing device to:
obtain video data including one or more video frames;
identify one or more body segments of one or more target subjects in each of the one or more video frames;
obtain audio data;
analyze the audio data to determine beat characteristics of each beat in the audio data;
determine a segmentation contour effect to be applied to the one or more body segments of the one or more target subjects in the one or more video frames based on the determined beat characteristics, wherein the beat characteristics control visualization changes of the segmentation contour effect on the one or more body segments throughout the one or more video frames;
generate the segmentation contour effect having a particular effect around boundaries of the one or more body segments of the one or more target subjects; and
generate a rendered video by synchronizing the segmentation contour effect to the audio data.

9. The computing device of claim 8, wherein the segmentation contour effect comprises contour effects parameters that define one or more behaviors of the segmentation contour effect to be added to the one or more body segments.

10. The computing device of claim 9, wherein the contour effects parameters define the one or more body segments that the segmentation contour effect is being applied to or how the one or more body segments are selected for segmentation contour effect application throughout the one or more video frames.

11. The computing device of claim 9, wherein the contour effects parameters define a color, width, height, thickness, and brightness of a segmentation contour for each segment of the one or more body segments.

12. The computing device of claim 9, wherein the contour effects parameters define a number of segmentation contours for a particular body segment to be added to the one or more video frames based on the beat characteristics.

13. (canceled)

14. The computing device of claim 8, wherein the beat characteristics include at least one selected from a group comprising a beat structure, a repeating sequence of strong and weak beats, a number of accented and unaccented beats, and relative positions of accented and unaccented beats.

15. A non-transitory computer-readable medium storing instructions for rendering a segmentation contour effect, the instructions when executed by one or more processors of a computing device, cause the computing device to:
obtain video data including one or more video frames;
identify one or more body segments of one or more target subjects in each of the one or more video frames;
obtain audio data;
analyze the audio data to determine beat characteristics of each beat in the audio data;
determine a segmentation contour effect to be applied to the one or more body segments of the one or more target subjects in the one or more video frames based on the determined beat characteristics, wherein the beat characteristics control visualization changes of the segmentation contour effect on the one or more body segments throughout the one or more video frames;
generate the segmentation contour effect, wherein the segmentation contour effect is an outline of the one or more body segments of the one or more target subjects; and
generate a rendered video by synchronizing the segmentation contour effect to the audio data.

16. The non-transitory computer-readable medium of claim 15, wherein the segmentation contour effect comprises contour effects parameters that define one or more behaviors of the segmentation contour effect to be added to the one or more body segments, wherein to generate the rendered video by synchronizing the segmentation contour effect to the audio data comprises to render the segmentation contour effect to a display based on the contour effects parameters.

17. The non-transitory computer-readable medium of claim 16, wherein the contour effects parameters define the one or more body segments that the segmentation contour effect is being applied to or how the one or more body segments are selected for segmentation contour effect application throughout the one or more video frames.

18. The non-transitory computer-readable medium of claim 16, wherein the contour effects parameters define a color, width, height, thickness, and brightness of a segmentation contour for each segment of the one or more body segments.

19. The non-transitory computer-readable medium of claim 16, wherein the contour effects parameters define a number of segmentation contours to be added to the one or more video frames based on the beat characteristics.

20. The non-transitory computer-readable medium of claim 15, wherein the beat characteristics include at least one selected from a group comprising a beat structure, a repeating sequence of strong and weak beats, a number of accented and unaccented beats, and relative positions of accented and unaccented beats.

21. The method of claim 1, wherein the segmentation contour effect is applied to different body segments of the one or more target subjects in a specified sequence.
